(19) United States
(12) Patent Application Publication
(10) Pub. No.: US 2025/0315816 A1
(43) Pub. Date: Oct. 9, 2025

(54) SYSTEM AND METHOD FOR STORING, TRADING, CRAFTING DIGITAL TOKENS, AND PLAYING GAMES USING SAID DIGITAL TOKENS

(71) Applicant: M-LEAGUE LTD., Singapore (SG)

(72) Inventors: Sai Srinivas Kiran GARIMELLA, Bengaluru (IN); Sishir Kolli, Bengaluru (IN)

(21) Appl. No.: 18/627,201

(22) Filed: Apr. 4, 2024

(51) Int. Cl. G06Q 20/36; A63F 13/63; A63F 13/792; G06Q 20/38; G06Q 40/04

(52) U.S. Cl. CPC G06Q 20/3672; A63F 13/63; A63F 13/792; G06Q 20/389; G06Q 40/04

(57) ABSTRACT

A system, including an online platform which is configured or built with a blockchain network, allows users to store, trade and craft in-game assets as digital tokens and allows users to play online games using the tokens over a computer network. The platform includes a registration module configured to register a plurality of users and a user account module configured to manage accounts associated with the users. The accounts include a wallet that stores the digital tokens and information pertaining to the tokens. The tokens being minted are recorded on the blockchain network. The platform includes a trading module configured to facilitate the plurality of users to trade the tokens across the games between the users. The platform includes a crafting module configured to facilitate the users to craft/create/modify/combine/upgrade the tokens. The system further includes one or more computing devices to access the platform.

### FIELD OF THE INVENTION

The present invention relates to a system and a computer-implemented method for allowing plurality of users to store, trade and craft in-game digital assets, such as non-fungible tokens (NFTs) and/or semi-fungible tokens (SFTs) and/or fungible tokens (FTs), and allowing the said users to play online games using those NFTs and/or SFTs and/or FTs within the said system.

### BACKGROUND OF THE INVENTION

Online platforms are known, where the users are allowed to play a particular game.

Referring to FIG. 2, currently, free to play or FTP games are available in the virtual world.

In such free to play games, players play the game for fun and some users spend money to acquire the game's currency.

The players use this game currency to acquire exclusive game assets and play the game using these gaming assets.

However, in such a model, the money spent by the players is distributed between the distributor and developer of the games, and no reward or money is derived by the players.

Further, these in-game digital assets do not ensure the uniqueness and/or scarcity of the assets, and any proof of the ownership of the assets.

More specifically, the non-fungible tokens certify authenticity, scarcity, exclusive licensing and ownership (as of the specific digital tokens and specific rights relating to it).

Therefore, converting these in-game digital assets into Non-Fungible tokens is desirable.

Non-fungible tokens are unique and non-interchangeable units of data stored on a digital ledger.

Semi-fungible tokens are unique as they combine the features of fungible and non-fungible tokens.

The NFTs can be used to represent reproducible items such as photos, videos, audio, and other types of digital files as unique items, and use blockchain technology to establish a verified and proof of licensing and/or ownership.

The blockchain technology has established a way to digitize all of our activities through cloud-based development. Various platforms are now built on the blockchain platform.

One such type of the said platform on the blockchain platform is disclosed in the United States publication number 2020/0038761.

The said '761 publication discloses a method for provisioning a market-based game on a blockchain platform that includes allocating a plurality of non-fungible tokens, each NFT representing a different real-life entity.

Another such type of platform is disclosed in the U.S. Pat. No. 11,238,477.

The patent document discloses an online platform that is based on blockchain.

The said platform includes one or more processors configured by machine-readable instructions to execute instances of a game and manage user accounts that includes a user account having an account inventory that includes a unique digital article.

The said platform is further receiving a recordation request to record ownership of the unique digital article on a decentralized ledger, determine a size of a set or population of unique digital articles, determine a fraction of the set or population of unique digital article recorded on the decentralized ledger.

However, these platforms have various drawbacks, one of such drawbacks is that they do not allow the users of the platform to trade in game non-fungible tokens on the platform.

Therefore, there is need to develop a platform which may allow the users to trade in-game tokens within a particular game or across games at large.

Further, there is a need to develop a system which may facilitate the users to transfer their in-game digital tokens from one game to another.

Furthermore, there is a need to develop a system which may reward the users of the platform for playing and/or trading within the games.

Moreover, there is a need to develop a system which enables the users to trade their tokens at a minimal gas fee.

In addition, there is a need for a system, wherein the users are allowed to upgrade, craft, create tokens by using their owned tokens, and may also play with those upgraded, created, crafted tokens and earn more rewards.

Further, there is a need for a system, wherein there is a possibility to establish a verified and proof of licensing and ownership.

In a nutshell, there is required a system and a method, which may overcome the above-discussed drawbacks and provide an easy to operate and cost-effective system allows the users to store, trade, craft and stake in-game non-fungible tokens, and allows the users to play online games using the non-fungible digital tokens.

### SUMMARY OF THE INVENTION

In an aspect of the present invention, a system and for allowing plurality of users to store, trade and craft in-game digital assets, such as NFTs and/or SFTs and/or FTs, and allowing the said users to play online games.

In an embodiment of the present invention, the said system includes an online platform such as including but not limited to gaming platform, which is configured or may be built with a block chain network, such as Polygon Proof-of-Stake (POS) blockchain network.

In an embodiment of the present invention, the said online platform hosts one or more online games.

In one embodiment of the present invention, the in-game tokens represent user controllable gaming avatars, characters, items, or the like.

In one embodiment of the present invention, the platform includes a registration module that is configured to register a plurality of users.

The said platform further includes a user account module that is configured to manage accounts associated with the plurality of users. The accounts include a linked digital wallet that stores the said gaming assets as tokens and information pertaining to the said tokens. The tokens being minted to be recorded on the said blockchain network.

In the embodiment of the present invention, the information pertaining to tokens includes rights reflecting ownership of the said tokens, transactions details of the said tokens, or the like.

Further, the platform includes a trading module that is configured to facilitate the plurality of users to trade the tokens across the games between the users.

More specifically, the trading module is configured to facilitate the plurality of users to buy the said tokens by game currency or real currency, and sell the said non-fungible tokens.

Accordingly, the ownership of the tokens is transferred to the buyer of the said tokens, and thereby new ownership recorded in the blockchain network or a centralized system or database.

In one embodiment of the present invention, the users are allowed to buy the said tokens at an ask price or place a bid.

In one embodiment of the present invention, the users are allowed to sell the said tokens by setting the ask price or by accepting the placed bid.

In various embodiments of the present invention, the said users are rewarded with fungible tokens after trading the said tokens.

The platform further includes a crafting module that is configured to facilitate the users to craft/create/modify/combine/upgrade the tokens by using the NFTs and fungible tokens.

In one embodiment of the present invention, the users are allowed to trade the crafted tokens for different prices.

In the embodiment of the present invention, the tokens may include without limitation, common tokens, rare tokens, unique/epic tokens, legendary tokens and mythical tokens.

In various embodiments of the present invention, the users of the system are allowed to play the one or more games by using the said in-game tokens, and based on that the users earn game currency.

In the embodiment of the present invention, the game currency may also be purchased by real money such as Fiat.

In one embodiment of the present invention, the users are allowed to stake the fungible tokens to get more tokens or game currency (premium currency) or rewards or the like, in return after a period of time.

In one embodiment of the present invention, the platform facilitates the game developers to launch and monetize their games via competitions and play to earn (P2E) mechanics by using software development kit (SDK) or Application programming interface (API) integration.

In one embodiment of the present invention, the platform facilitates the various creators to develop unique tokens and upload these tokens in the said platform.

In the embodiment of the present invention, the said tokens undergo a curation process for selection, and thereafter get recorded in the blockchain network, and introduced in the one or more games as in-game tokens.

This together with the other aspects of the present invention along with the various features of novelty that characterized the present disclosure is pointed out with particularity in claims annexed hereto and forms a part of the present invention. For a better understanding of the present disclosure, its operating advantages, and the specified objective attained by its uses, reference should be made to the accompanying descriptive matter in which there are illustrated exemplary embodiments of the present invention.

### DESCRIPTION OF THE DRAWINGS

The advantages and features of the present invention will become better understood with reference to the following detailed description taken in conjunction with the accompanying drawings, in which:

FIG. 1 illustrates a schematic diagram representing a system for storing, trading and crafting gaming assets as non-fungible digital tokens or NFTs, and/or semi fungible tokens (SFTs), and/or fungible tokens (FTs) and allowing users to play online games using the said tokens, according to various embodiments of the present invention;

FIG. 2 illustrates game flow of free to play games, according to various embodiments of the present invention;

FIG. 3 illustrates a snapshot representing multiple exemplary rarities of the digital tokens, according to various embodiments of the present invention;

FIG. 4 illustrates a schematic diagram representing a trade between the users/players of the platform of FIG. 1, according to various embodiment of the present invention;

FIG. 5 illustrates a snapshot representing a trading module of the online platform of FIG. 1, according to various embodiments of the present invention;

FIG. 6 illustrates an exemplary flowchart representing a process for setting an ask price for the tokens, according to various embodiments of the present invention;

FIG. 7 illustrates an exemplary flowchart representing a process for buying the tokens, according to various embodiments of the present invention;

FIG. 8 illustrates a schematic diagram representing a purchase of the tokens listed as default in the online platform of FIG. 1, according to various embodiments of the present invention;

FIG. 9A illustrates a snapshot representing crafting of in-game assets as digital tokens, according to exemplary embodiment of the present invention;

FIG. 9B illustrates a snapshot representing a crafted in game non-fungible token of FIG. 10A, according to exemplary embodiment of the present invention;

FIG. 10 illustrates a diagram representing currency flow in the platform of FIG. 1, according to various embodiments of the present invention;

FIG. 11 illustrates a schematic diagram representing a player playing the game in the platform of FIG. 1 and earning game currency, according to various embodiments of the present invention; and

FIG. 12 illustrates an exemplary flowchart representing a computer-implemented method for allowing a plurality of users to store, trade and craft in-game assets as non-fungible tokens (NFTs) and/or semi fungible tokens (SFTs) and/or fungible tokens (FTs) in an online platform, and allowing the users to paly online games using the said tokens, according to various embodiments of the present invention.

Like numerals denote like elements throughout the figures.

### DESCRIPTION OF THE INVENTION

The exemplary embodiments described herein detail for illustrative purposes are subjected to many variations. It should be emphasized, however, that the present invention is not limited to as disclosed.

It is understood that various omissions and substitutions of equivalents are contemplated as circumstances may suggest or render expedient, but these are intended to cover the application or implementation without departing from the spirit or scope of the present invention.

Specifically, the following terms have the meanings indicated below.

The terms “a” and “an” herein do not denote a limitation of quantity, but rather denote the presence of at least one of the referenced items.

The terms “having”, “comprising”, “including”, and variations thereof signify the presence of a component.

The present invention discloses a system for allowing a plurality of the users to store, trade and craft gaming assets, in form of non-fungible and/or semi-fungible digital tokens and/or fungible tokens, and allowing the said plurality of users to play online games using the said non-fungible digital tokens, over a computer network.

The term “non-fungible token (NFT)” herein refers to a unit of information stored on a digital ledger, called a blockchain, that certifies digital tokens to be unique and therefore not interchangeable.

More specifically, NFTs certify authenticity and ownership (as of the specific digital tokens and specific rights relating to it).

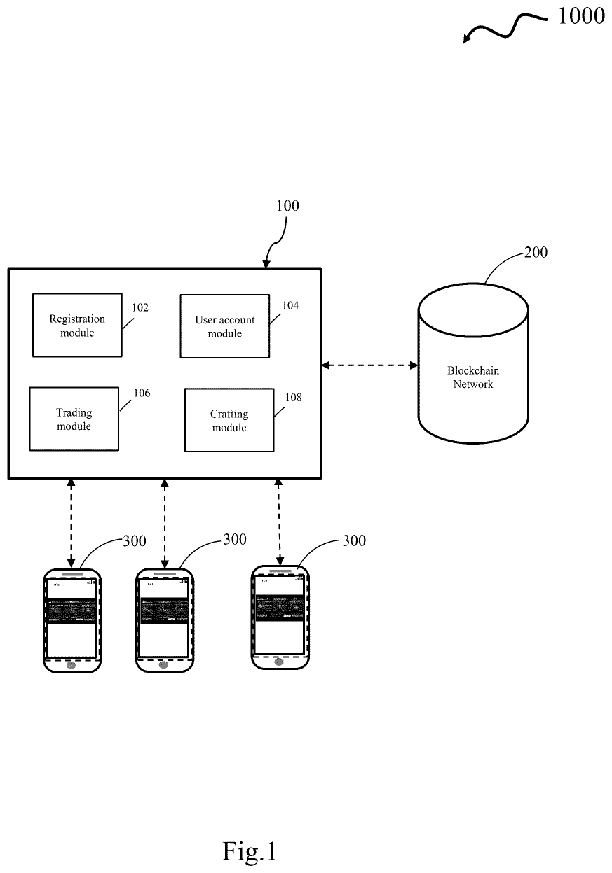

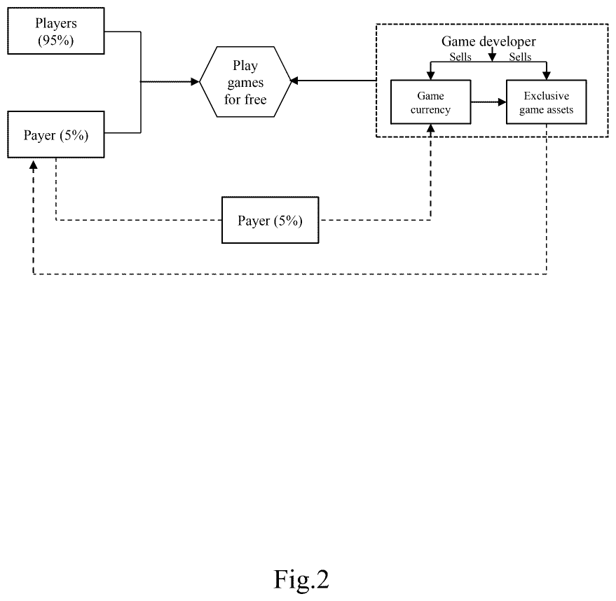

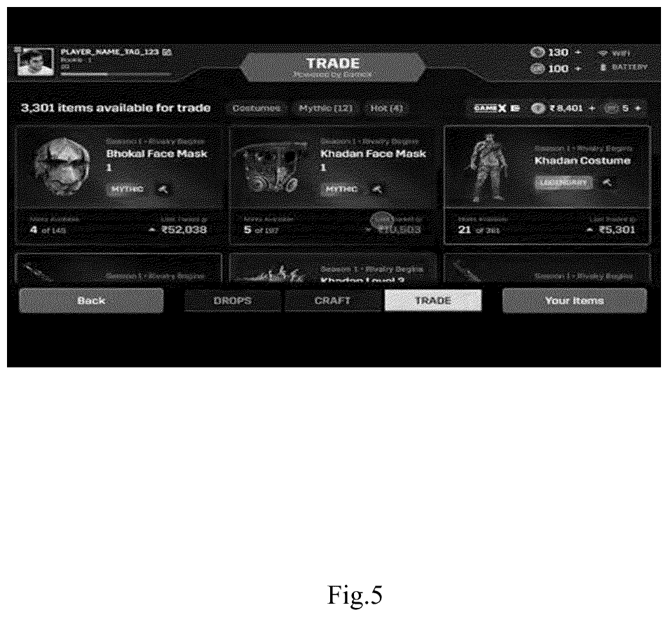

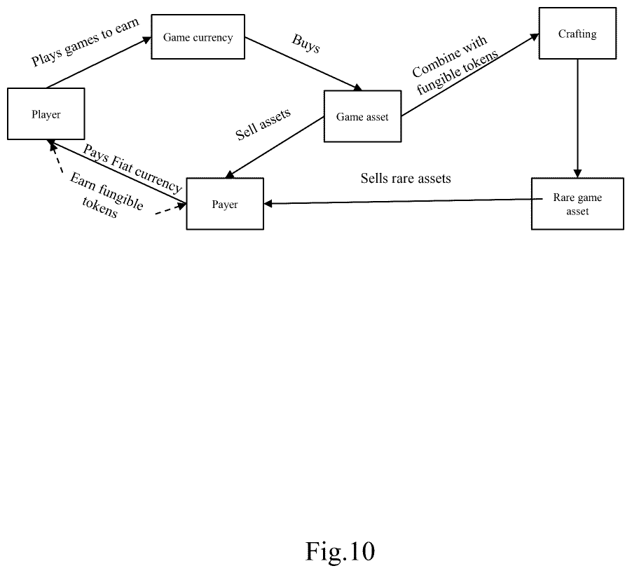

Now, the inventive aspects of the invention along with various components and engineering involved will now be explained with reference to FIGS. 1-12 herein.

Referring to FIG. 1, a system (1000) for storing, trading and crafting gaming assets, such as non-fungible and/or semi-fungible tokens and/or fungible tokens, and allowing the users to play online games using the said tokens, according to various embodiments of the present invention is disclosed.

In an embodiment of the present invention, the system (1000) includes an online platform (100) such as including but not limited to gaming platform, which is configured or built on a blockchain network, such as on Polygon Proof of Stake (POS) blockchain network (200) (refer FIG. 1).

It will be understood to the persons skilled in the art that the Polygon (POS) is a layer 2 scaling solution that achieves scale by utilizing side-chains for off-chain computation, while ensuring asset security using the Plasma framework and a decentralized network of Proof-of-Stake (POS) validators. However, it should be understood that the cited example of PoS is only exemplary. Accordingly, the system (1000) is chain-agnostic, and accordingly, the system (1000) can be on other blockchains as well.

Coming back to the platform, the NFTs/SFTs/FTs in the platform (100) represent user controllable gaming avatars, characters, items, or the like.

In one embodiment of the present invention, the platform (100) includes a registration module (102) that is configured to register a plurality of users (refer FIG. 1).

Referring to FIG. 1, the platform (100) includes a user account module (104) that is configured to manage accounts associated with the plurality of users.

The said accounts include a user linked digital wallet that stores the said gaming assets as NFTs/SFTs/FTs and information pertaining to the said tokens.

In the said embodiment of the present invention, the said tokens are being minted to be recorded on the said blockchain network (200).

The term “minting” herein refers to a process of turning the digital assets (100) into a part of the blockchain (200). Minting involves assigning the ownership to the said tokens for ensuring authenticity.

In various embodiments of the present invention, the information pertaining to tokens includes rights reflecting ownership of the said tokens, transactions details of the said tokens, or the like.

In a particular embodiment of the present invention, the said tokens are recorded on the blockchain (200).

In an exemplary embodiment of the present invention, the said tokens without limitation are recorded on the blockchain (200) based on the rarity of the said tokens.

The term “rarity” herein refers to the availability of the said in the said platform (100).

In the exemplary embodiment of the present invention, the tokens of higher rarity may include more characteristics as compared to the tokens of the lower rarity in the games.

In one embodiment of the present invention, the NFTs/SFTs/FTs may be available in limited number in the platform (100).

In one embodiment of the present invention, some NFTs/SFTs/FTs may have more availability in the said platform (100).

More specifically, in an exemplary embodiment, the said tokens are divided into, without limitation such as common tokens, rare tokens, epic tokens, legendary tokens and mythical tokes.

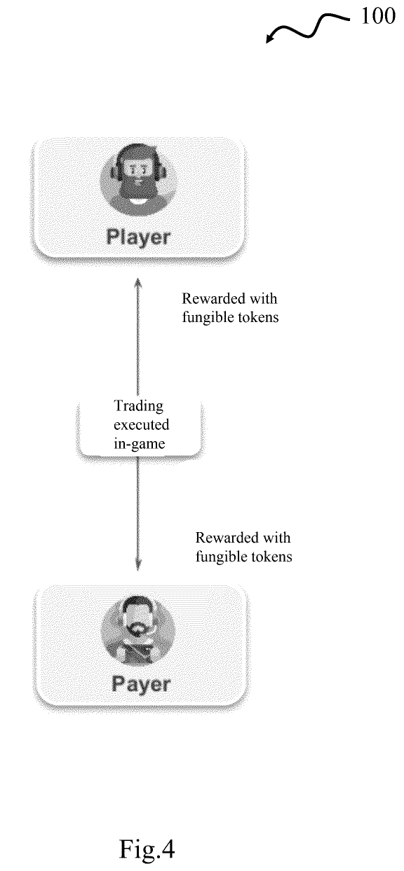

Again, referring to FIGS. 1, 4 & 5, the said platform (100) includes a trading module (106) that is configured to facilitate the plurality of users to trade the said token/s across the online games between the plurality of users.

In the embodiment of the present invention, the said token/s may be traded before the game, during the game or after the completion of game.

In one embodiment of the present invention, the said trading module (106) is configured to facilitate the plurality of users to sell the said token/s to other users.

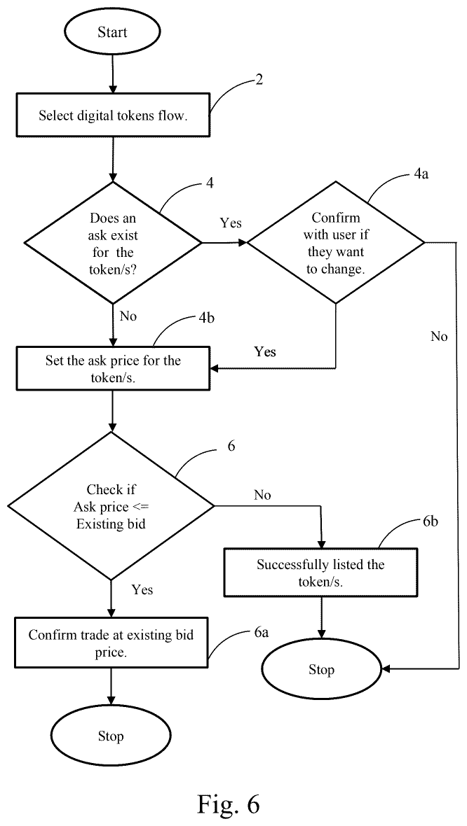

Referring to FIG. 6, a flowchart illustrating a process which allows the users to sell their token/s.

At step (2), the users are allowed to select the token/s, they want to sell.

After that at step (4), the users are allowed to check the existing ask price of the said token/s.

In the embodiment of the present invention, if there exists the ask price for the token/s, then at step (4a), the users are allowed to confirm with the users if they want to change the ask price for the said token/s.

In the embodiment of the present invention, if the users are willing to change the asking price of the said tokens, then the users follow step (4b) (Refer to FIG. 6).

In the embodiment of the present invention, if there is no ask price for the token/s, then the users are allowed to set the ask price for the said token/s, as shown in step (4b) (Refer to FIG. 6).

Thereafter, at step (6), the users are allowed to check the existing bid for the said token/s placed by other users of the platform (100) (Refer to FIG. 6).

In one embodiment of the present invention, if the bid for token/s is greater or equal to the asked price, then the user may sell their token/s as shown in step (6a).

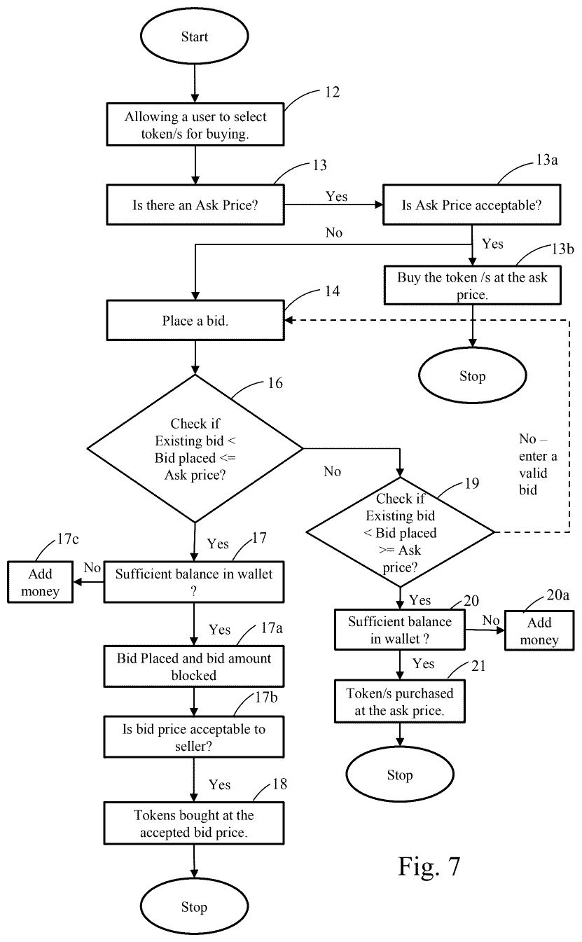

In another embodiment of the present invention, if the bid for token/s is lower than the ask price, then the users may not sell their NFT/s, and thereby just list the said token/s for selling, as shown in step (6b) (Refer to FIG. 7).

In various embodiments of the present invention, the platform (100) allows the users to delist the token/s from selling.

In another embodiment of the present invention, the users are allowed to buy the said token/s from the developers of the games or from the other users of the platform (100).

Referring to FIG. 7, there is shown a flowchart illustrating a process which allows the users to buy the said token/s.

Referring to FIG. 7, at step (13), the user is allowed to check for an ask price for the token/s (100).

Thereafter, if the ask price is available for the token/s, then there is a need to check whether the said ask price is acceptable or not at step (13a)?

If the ask price is acceptable, then the user is simply allowed to buy the token/sat the said ask price at step (13b).

However, if the ask price is not acceptable, then the user is allowed to place a bid for the said token/sat step (14) (Refer to FIG. 7).

Subsequently, at step (16), the process involves checking the existing bid for the said token/s (Refer to FIG. 7).

In the embodiment of the present invention, if the existing bid is lower than the placed bid, however, on the other hand, the placed bid is lesser than the ask price of the said token/s, then the balance in the wallet of the user/s is checked before allowing the user to buy the said token/s as shown at step (17).

In the embodiment of the present invention, if there is sufficient balance in the wallet, then the bid for token/s gets placed and a bid amount gets blocked at step (17a).

Alternatively, if there is no sufficient balance in the wallet, then the user is allowed to add money at step (17c) (Refer FIG. 7) in order to facilitate the buying.

In the said embodiment of the present invention, after a successful bid is placed, there is additionally a need to check if the placed bid is acceptable to the owner/seller of the token/s at step (17b).

In the embodiment of the present invention, if the placed bid is accepted by the seller/owner of the token/s, then the user is allowed to buy the token/s at the accepted bid price at step (18) (Refer FIG. 7).

In the embodiment of the present invention, if, however the placed bid is greater than or equal to the ask price of the token/s as shown in step (19), then the balance in a wallet of the user is directly checked before the step of buying the said token/s as shown at step (20) (Refer FIG. 7).

In the embodiment of the present invention, if there is sufficient balance in the wallet, then the user is asked to buy the said token/s at the ask price as shown in step (21), however, if there is no sufficient balance in the wallet, then the user is allowed to add money in the wallet at step (20a). (Refer FIG. 7).

In another embodiment of the present invention, if the existing bid is higher than the placed bid, then the user is allowed to place another valid bid for the said token/s by following step (14).

In this manner, the trading of in-game token/s is carried out in the present invention.

In the embodiment of the present invention, the said token/s are purchased by game currency (premium currency of the platform (100)) or real currency.

In various embodiments of the present invention, the ownership of the token/s is transferred to the buyers, and the new ownership is recorded in the blockchain network (200).

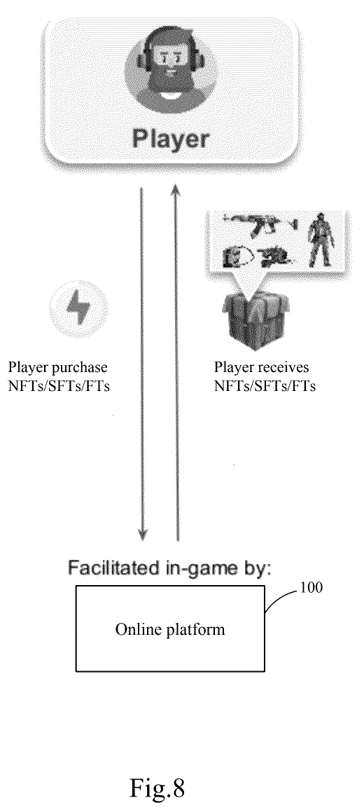

In another embodiment of the present invention, the users are allowed to purchase the token/s which are listed as default in the said platform (100) (refer FIG. 8).

In various embodiments of the present invention, the plurality of users may earn fungible tokens for buying or selling the token/s.

More specifically, both the buyer and seller may be rewarded with an equal number of fungible tokens as shown in FIG. 4.

The “fungible tokens” as mentioned herein are “fungible ERC20 tokens” that are minted on the blockchain network (200).

In the embodiment of the present invention, these fungible tokens are tradeable between users on the platform (100).

Coming back to FIG. 1, the platform (100) further includes a crafting module (108) that facilitates the plurality of the users to combine/upgrade/modify tokens.

In the embodiment of the present invention, the tokens along with the fungible tokens are used to craft/modify/upgrade the tokens.

In one embodiment of the present invention, the users may also trade the said crafted in-game tokens for different prices.

In the embodiment of the present invention, each crafted token has a unique hash ID that helps to distinguish the crafted tokens and map it to the users.

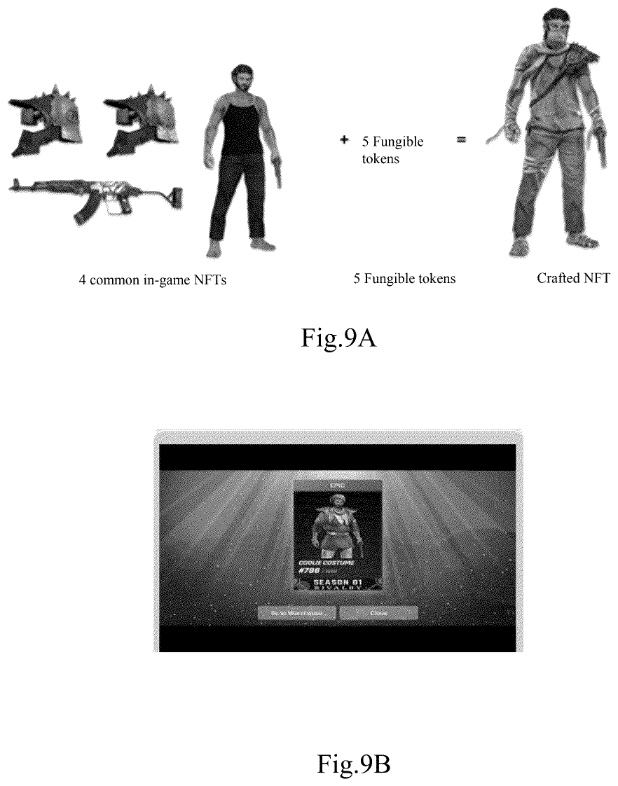

In an exemplary embodiment of the present invention, the users may need four (4) common NFTs along with five (5) fungible tokens to craft NFT as shown in FIG. 9A.

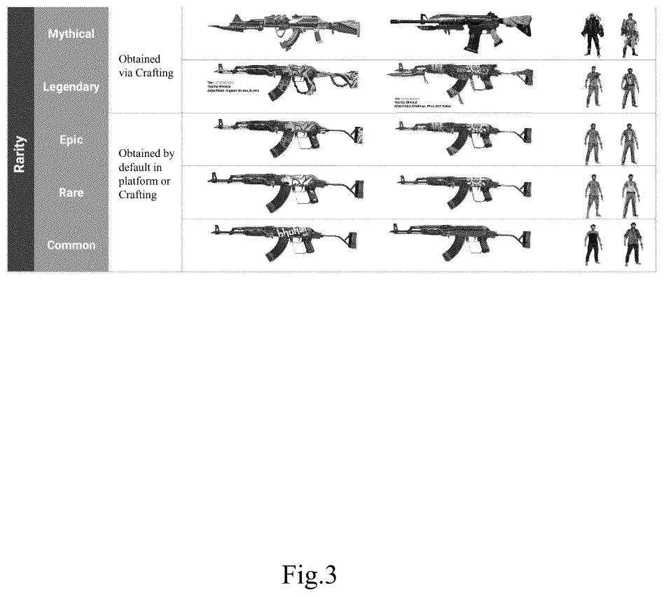

In one exemplary embodiment of the present invention, common tokens, rare tokens and epic tokens may be obtained by default or crafting, and legendary and mythical tokens may only be obtained by crafting the tokens as shown in FIG. 3.

In various embodiments of the present invention, the users may use these crafted tokens for playing the games.

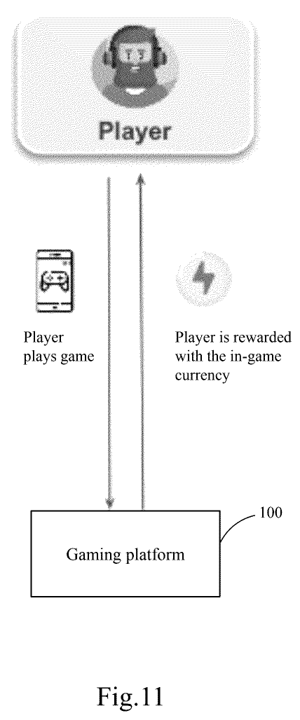

In various embodiments of the present invention, the users of the platform (100) earn game currency (premium currency), rewards or the like, for playing the games available on the platform (100) (refer FIG. 11).

In the embodiment of the present invention, the said game currency may also be purchased by the real currency such as fiat or the like.

In one embodiment of the present invention, the platform (100) allows the new game developers to launch and monetize their games via competitions and play to earn (P2E) mechanics by using software development kit (SDK) integration and Application programming interface (API) integration.

The “software development kit (SDK)” is a collection of software development tools in one installable package. They facilitate the creation of applications by having a compiler, debugger and sometimes a software framework.

The “programming interface (API)” is a messenger that processes request and ensures seamless functioning of enterprise systems.

They are normally specific to a hardware platform and operating system combination. To create applications with advanced functionalities such as advertisements, push notifications, etc.; most application software developers use specific software development kits.

In one embodiment of the present invention, the platform (100) allows the various creators to develop unique in-game digital tokens and upload these tokens in the said platform (100).

In the embodiment of the present invention, these uploaded tokens undergo a curation process and selected tokens get recorded in the blockchain network (200) and introduced in the game as in-game tokens.

In one embodiment of the present invention, the system (1000) further includes one or more computing devices (300).

The computing devices (300) allow the users to access the platform (100) for performing various functions of the platform (100) (refer FIG. 1).

In the embodiment of the present invention, the said computing devices (300) may be any computing device, such as smart phones, tablets, computer, or the like.

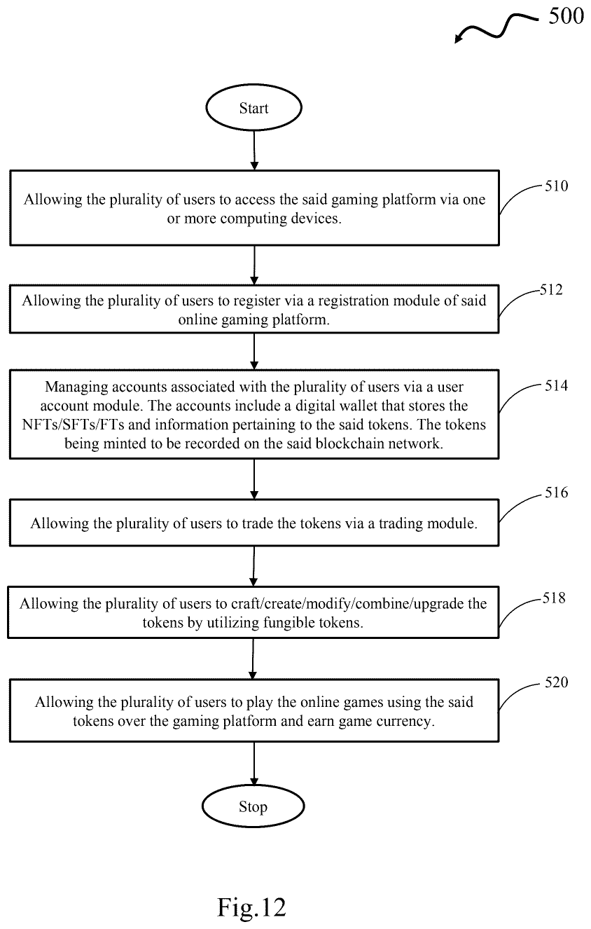

In various embodiments of the present invention, referring to FIG. 12, a flowchart is representing a computer-implemented method (500) for allowing a plurality of users to store, trade and craft in-game assets as non-fungible tokens or NFTs and/or semi fungible tokens (SFTs) and/or fungible tokens (FTs) in an online platform (100) which is discussed above, and allowing the said plurality of users to play over a computer network.

Referring to FIGS. 1 & 12 at step (510), the computer implemented method (500) allows the plurality of users to access the said platform (100) via one or more computing devices (300).

The said method (500), further at step (512), involves allowing the plurality of users to register via the registration module (102) of the said online platform (100) (refer FIG. 12).

Further, at step (514), the method involves managing accounts associated with the plurality of users via the user account module (104).

In the embodiment of the present invention, the accounts include a digital wallet that stores the said tokens and information pertaining to the said tokens.

In the embodiment of the present invention, the said tokens are being minted to be recorded on the said blockchain network (200).

Again, referring to FIG. 12, the method (500) further involves the plurality of users to trade the plurality of non-fungible digital tokens via the trading module (106) as shown in step (516).

Further, at step (518), the method (500) allows the user to craft/create the non-fungible tokens via the crafting module (108).

The method (500), at step (520), allows the users to play the said games and earn game currency by playing.

### Advantages of the Invention

In the various embodiments of the present invention, the platform of the present invention rewards the users with real currency, in-game digital assets, game currency, or the like.

Further, in the present invention, the users may also trade their NFTs/SFTs/FTs before the game, during the on-going game, or after the completion of the game.

Furthermore, in the present invention, the users may sell their tokens at a price higher than the price they had purchased before, and on successful trading both the buyer and seller are rewarded with fungible tokens.

Moreover, building the platform on the Polygon POS blockchain network have following benefits:
increases the scalability of the transactions per second as compared to other blockchain network,
increases the speed of the transactions,
reduces the gas cost or in enable meta (gas-less) transactions over the platform, and
provides better security.

In addition, the users may also craft/modify/upgrade the tokens and may play the games with the said crafted tokens. The crafted tokens in some instances may enable the users to earn more rewards.

The online platform of the present invention allows the game developers to launch their games, this may provide economy to the game developers.

The platform of the present invention also allows the various creators to develop their NFTs and upload their NFTs, this may provide economy to the creators.

In various embodiments, the platform of the present invention may also allow the users to stake their NFTs and/or semi fungible tokens or fungible tokens to get more tokens, or game currency (premium currency) or rewards or the like in return after a period of time.

In nutshell, the system of the present invention overcomes the above-discussed drawbacks which are discussed in the background of the invention and provides an easy to operate and cost-effective online platform for storing, trading and crafting the non-fungible tokens and/or semi fungible tokens and/or fungible tokens.

The method, as described in the disclosed teachings or any of its components, may be embodied in the form of a computer implemented method.

Typical examples of a computer included in the computer implemented method include a general-purpose computer, a PDA, a cell phone, a programmed microprocessor, a microcontroller, a peripheral integrated circuit element, and other devices or arrangements of devices that are capable of implementing the steps that constitute the method of the disclosed teachings.

In a computer implemented method using a general-purpose computer, such a general-purpose computer can include an input device such as keyboard, a mouse, a trackball, a touchpad, a microphone, or a camera. The computer can include a display unit, such as a projector, a monitor, or a touch screen. A touch screen can also be used as an input device. Specifically, the computer of the computer implemented method can comprise a hardware microprocessor, where the microprocessor is connected to a communication bus.

The computer implemented method can also include a memory; the memory can include Random Access Memory (RAM) and Read Only Memory (ROM).

The computer of the computer implemented method can further comprise a non-transitory computer readable medium such as a storage device, which can be a hard disk drive or a removable storage drive such as a flash drive, optical disk drive, and the like. The storage device can also comprise other similar means for loading computer programs or other instructions into the computer of the computer implemented method.

The computer of the computer implemented method may comprise a communication device to communicate with a remote computer through a network. The communication device can include a wireless communication port, a data cable connecting the computer of the computer implemented method with the network, or the like. The network can be a Local Arca Network (LAN) or a Wide Area Network (WAN) such as the Internet and the like.

The remote computer that is connected to the network can be a general-purpose computer, a server, a PDA, and the like. Further, the computer implementing the computer implemented method can access information from the remote computer through the network.

The sets of instructions stored on the computer readable medium include various commands that instruct the computer of the computer implemented method to perform specific tasks such as the steps that comprise the methods of the disclosed teachings.

The sets of instructions may be embodied in the form of a transitory medium, such as a software program.

The software may be in various forms such as method software or application software. Further, the software might be in the form of a collection of separate programs, a program module with a larger program or a portion of a program module. The software might also include modular programming in the form of object-oriented programming.

The software program or programs may be provided as a computer program product, such as in the form of a computer readable medium with the program or programs containing the set of instructions embodied therein. The processing of input data by the computer of the computer implemented method may be in response to user commands or in response to the results of previous processing or in response to a request made by another computer.

The foregoing descriptions of specific embodiments of the present invention have been presented for purposes of description. They are not intended to be exhaustive or to limit the present invention to the precise forms disclosed, and obviously many modifications and variations are possible in light of the above teaching.

Further, the embodiments were chosen and described in order to best explain the principles of the present invention and its practical application, and thereby enable others skilled in the art to best utilize the present invention and various embodiments with various modifications as are suited to the particular use contemplated.

It is understood that various omissions and substitutions of equivalents are contemplated as circumstances may suggest or render expedient, but such omissions and substitutions are intended to cover the application or implementation without departing from the spirit or scope of the present invention.

We claim:

1. A system for allowing a plurality of the users to store, trade and craft in-game assets, such as digital tokens, and allowing the said plurality of users to play online games using the said tokens over a computer network, the system comprising:
an online platform configured or built with a blockchain network, comprising,
a registration module configured to register a plurality of users;
a user account module configured to manage accounts associated with the plurality of users, wherein the accounts comprise a linked digital wallet that stores the said gaming assets as digital tokens and information pertaining to the said the said tokens, the said tokens being minted to be recorded on the said blockchain network,
a trading module configured to facilitate the plurality of users to trade the said tokens across the online games between the plurality of users, wherein the system comprises,
a crafting module configured to facilitate the plurality of the users to craft/create/modify/combine/upgrade the tokens; and
one or more computing devices configured for allowing the plurality of the users to access the said platform for storing, trading, upgrading, and crafting the in-game assets as digital tokens, and allowing the users to play the online games within the system.

2. The system as claimed in claim 1, wherein the said platform hosts one or more online games.

3. The system as claimed in claim 1, wherein the information pertaining to tokens comprises information and rights reflecting ownership of the said tokens as applicable, transactions details of the said tokens, or the like, among others.

4. The system as claimed in claim 1, wherein the trading module configured to facilitate the plurality of users to,
buy the said tokens by game currency or real currency,
buy the fungible tokens by real currency, and
sell the said tokens, wherein the ownership is transferred to the buyer, and thereby recorded in the blockchain network.

5. The system as claimed in claim 4, wherein the users are allowed to buy the said tokens at an ask price or placed bid.

6. The system as claimed in claim 4, wherein the users are allowed to sell the said tokens by setting the ask price or by accepting the placed bid.

7. The system as claimed in claim 4, wherein the said users are rewarded with the fungible tokens after trading the said tokens.

8. The system as claimed in claim 7, wherein the said fungible tokens are utilized to craft/create the tokens.

9. The system as claimed in claim 8, wherein the tokens comprise without limitation, common tokens, rare tokens, unique/epic tokens, and legendary tokens.

10. The system as claimed in claim 1, wherein the said in-game tokens represent user controllable gaming avatars, characters, items, or the like.

11. The system as claimed in claim 1, wherein the users are allowed to play the one or more games by using the said in-game tokens, and based on that the users may earn game currency.

12. The system as claimed in claim 1, wherein the game currency may also be purchased by real currency.

13. The system as claimed in claim 1, wherein the users are allowed to stake the fungible tokens to get more tokens in return after a period of time.

14. The system as claimed in claim 1 facilitates the game developers to launch and monetize their games via competitions and play to earn (P2E) mechanics by using software development kit (SDK) integration or Application programming interface (API).

15. The system as claimed in claim 1, wherein the users are allowed to trade the crafted tokens.

16. The system as claimed in claim 1 facilitates the various creators to develop unique digital tokens and upload these tokens in the said platform, wherein the said tokens undergo a curation process for selection, and thereafter get recorded in the blockchain network, and introduced in the one or more games as in-game tokens.

17. A computer implemented method for allowing a plurality of users to store, trade, modify/combine/upgrade/craft in-game assets, such as digital tokens in an online platform, and allowing the users to play online games using the said tokens, wherein the said platform is configured or built with a blockchain network, the said method comprising:
allowing the plurality of users to access the said platform via one or more computing devices;
allowing the plurality of users to register via a registration module of the said online platform;
managing accounts associated with the plurality of users via a user account module, wherein the accounts comprise a linked digital wallet that stores the said tokens and information pertaining to the said tokens, the said tokens being minted to be recorded on the said blockchain network;
allowing the plurality of users to trade the plurality of non-fungible digital tokens via a trading module;
allowing the plurality of users to craft/create/modify/combine/upgrade the tokens via a crafting module; and
allowing the plurality of users to play the online games over the platform by using the said tokens and earn game currency.

18. The method as claimed in claim 17, wherein the said platform hosts one or more online games.

19. The method as claimed in claim 17, wherein the information pertaining to tokens comprise rights reflecting ownership of the said tokens, transactions details of the said tokens, or the like.

20. The method as claimed in claim 17 comprising allowing the users to set an ask price or accept the placed bid to sell the said tokens.

21. The method as claimed in claim 17 comprising allowing the users to place a bid to buy the said tokens, wherein the ownership is transferred to the buyer, and thereby recorded in the blockchain network.

22. The method as claimed in claim 17, wherein the said users are rewarded with fungible tokens after trading the said tokens.

23. The method as claimed in claim 22, wherein the said fungible tokens are utilized to craft/create/modify/upgrade the tokens.

24. The method as claimed in claim 23, wherein the tokens comprise but not limited to common tokens, rare tokens, unique/epic tokens, and legendary tokens.

25. The method as claimed in claim 17, wherein the said in-game tokens represent user controllable gaming avatars, characters, items, or the like.

26. The method as claimed in claim 17, wherein the users are allowed to play the one or more games by using the said in-game tokens, and based on that the users earn game currency, wherein the game currency may also be purchased by real currency.

27. The method as claimed in claim 17, comprising allowing the users to stake the tokens to get more tokens in return after a period of time.

28. The method as claimed in claim 17 comprises facilitating the game developers to launch and monetize their games via competitions and play to earn (P2E) mechanics by using Application programming interface (API) or software development kit (SDK) integration.

29. The method as claimed in claim 17 facilitating the various creators to develop unique and upload these digital tokens in the said platform, wherein the said tokens undergo a curation process for selection, and thereafter get recorded in the blockchain network, and introduced in the one or more games as in-game tokens.
